(19) United States
(12) Patent Application Publication
(10) Pub. No.: US 2026/0277264 A1
(43) Pub. Date: Sep. 17, 2026

(54) REFERENCE VOLTAGE GENERATION CIRCUIT AND SEMICONDUCTOR DEVICE

(71) Applicant: Winbond Electronics Corp., Taichung City (TW)

(72) Inventors: Yasue Yamamoto, Tokyo (JP); Hiroki Murakami, Chuou-Ku Saitama City (JP)

(73) Assignee: Winbond Electronics Corp., Taichung City (TW)

(21) Appl. No.: 19/414,292

(22) Filed: Dec. 10, 2025

(30) Foreign Application Priority Data
Mar. 13, 2025 (JP) 2025-040231

(51) Int. Cl. G05F 3/26

(52) U.S. Cl. CPC G05F 3/267

(57) ABSTRACT

A reference voltage generation circuit for generating a stable reference voltage when power is turned on or the like is provided. The reference voltage generation circuit of the present invention includes: a BGR circuit that generates a current utilizing a bandgap of a diode-connected bipolar transistor in a first current path; a voltage generation part that replicates the current in a second current path and generates a reference voltage based on the current; and a resistor control part that controls resistance values of a variable resistor in the first current path and a variable resistor in the second current path. The resistor control part makes the resistance values of the variable resistors to be smaller than those during a normal operation when a power voltage is supplied, thereby increasing current capacity flowing in the first current path and the second current path, and suppressing overflow of the reference voltage caused by an inrush current.

### CROSS-REFERENCE TO RELATED APPLICATION

This application claims the priority benefit of Japan application serial no. 2025-040231, filed on Mar. 13, 2025. The entirety of the above-mentioned patent application is hereby incorporated by reference herein and made a part of this specification.

### BACKGROUND

### Technical Field

The present invention relates to a reference voltage generation circuit that generates a reference voltage, and particularly relates to a technology that generates the reference voltage using a bandgap reference circuit (hereinafter referred to as a BGR circuit).

### Related Art

In semiconductor devices such as a memory or a logic, a bandgap reference (BGR) circuit is used to generate a reference voltage or a reference current that does not depend on a power voltage, a temperature, or a process (for example, Japanese Patent No. 7103742). The reference voltage generated by the BGR circuit is used, for example, as a reference for a comparator, and the reference current is used, for example, in analog circuits such as amplifiers.

### SUMMARY

FIG. 1 is a diagram of an example of a conventional reference voltage generation circuit. The reference voltage generation circuit 10 includes a BGR circuit 20 and a voltage generation part 30. The BGR circuit 20 includes a first current path and a second current path between a power voltage Vcc supplied from outside and ground (GND), wherein a P type metal oxide semiconductor (PMOS) transistor P1 and a PNP bipolar transistor Q1 are connected in series in the first current path, and a PMOS transistor P2, a resistor R1, and a PNP bipolar transistor Q2 are connected in series in the second current path. The BGR circuit 20 further includes a differential amplifier AMP, wherein the differential amplifier AMP receives a node VN connecting the transistor P1 and the transistor Q1 at an inverting input terminal (−), receives a node VP connecting the transistor P2 and the resistor R1 at a non-inverting input terminal (+), and connects an output terminal to a common gate of the transistor P1 and the transistor P2.

Bases and collectors of the transistor Q1 and the transistor Q2 are both connected in a diode configuration, an emitter area ratio of the transistor Q1 and the transistor Q2 is 1 to N (Nis a number greater than 1), and current density of the transistor Q1 is n times that of the transistor Q2. Furthermore, although the bipolar transistor Q1 and the bipolar transistor Q2 are used here, diodes may also be used to replace the bipolar transistor Q1 and the bipolar transistor Q2. For example, one diode may be used to replace the transistor Q1, and n diodes connected in parallel may be used to replace the transistor Q2.

The transistor P1 and the transistor P2 serve as current sources, supplying equal current to the first current path and the second current path, and the differential amplifier AMP controls a gate voltage of the transistor P1 and the transistor P2 to make the node VN equal to the node VP (VN=VP). The current iBGR flowing through the first current path and the second current path is expressed by the following equation.

$$iBGR = ( 1 / R 1 ) \times Vt \times ln ( n )$$

where Vt-kT/q (k is Boltzmann constant, T is an absolute temperature, q is charge quantity)

The current iBGR is a current that is not affected by the power voltage Vcc and is proportional to the temperature (Proportional To Absolute Temperature, PTAT).

The voltage generation part 30 includes a third current path between the power voltage Vcc and GND, wherein a PMOS transistor P3, a resistor R2, and a bipolar transistor Q3 are connected in series in the third current path. Additionally, a resistor R3 is connected in parallel with resistor R2. The transistor P3 is a current mirror sharing a gate with the transistor P2 to replicate current iBGR in the third current path. The resistor R2 and the resistor R3 have positive temperature coefficients, a forward voltage VBE3 of the transistor Q3 has a negative temperature coefficient, and the resistor R2 and the resistor R3 are selected to eliminate the temperature dependence of the current iBGR and obtain a desired output voltage Vout. Thus, an output voltage Vout or reference voltage Vref that is not affected by the power voltage Vcc, an operating temperature, and the process may be generated.

FIG. 2 is a diagram of an example of an internal voltage generation circuit. The internal voltage generation circuit 40 generates an internal supply voltage INTVDD based on the reference voltage Vref output from the reference voltage generation circuit 10. The internal voltage generation circuit 40 includes an operational amplifier AMP2 and a PMOS transistor P4, wherein an inverting input terminal (−) of the operational amplifier AMP2 inputs the reference voltage Vref, and a non-inverting input terminal (+) feedback inputs the voltage of a node N. A resistor R4 and a resistor R5 are connected in series to the transistor P4, and a connection point of the resistor R4 and the resistor R5 forms the node N. The internal supply voltage INTVDD is generated at the node where the resistor R4 and the transistor P4 are connected. The operational amplifier AMP2 controls a gate voltage of the transistor P4 to make a voltage of the node N equal to the reference voltage Vref, the current flowing through the transistor P4 becomes a constant current that is not affected by variations in the power voltage Vcc, and the internal supply voltage INTVDD is generated based on this constant current and the reference voltage Vref. The internal supply voltage INTVDD is supplied to internal peripheral circuits.

FIG. 3(A) to FIG. 3(C) are waveform diagrams of various parts of a conventional reference voltage generation circuit during power-on. When power is turned on, the power voltage Vcc supplied to the semiconductor device rises at different rates depending on factors such as the operating environment, and is not consistent. A, B, C, and D in FIG. 3(A) respectively represent different slopes of the power voltage Vcc rising to 3.6 V. For example, in a case of the slope A (500 μs/V), the time t to reach 3.6 V is approximately 1.8 ms, under the slope B (100 μs/V) it is approximately 360 μs, under the slope C (70 μs/V) it is approximately 250 μs, and under the slope D (50 μs/V) it is approximately 180 μs.

When using a low current such as the current iBGR=0.125 uA in a wide range of products, there exists the following issue: if the power voltage Vcc rises with a steep slope, the reference voltage Vref generated by the reference voltage generation circuit 10 may overflow. A1, B1, C1, and D1 in FIG. 3(B) represent the overflow of the reference voltage Vref corresponding to the slopes A, B, C and D of the power voltage Vcc. The stable reference voltage Vref after the power voltage Vcc reaches 3.6 V is 1.1 V. It can be seen that if the slope of the power voltage Vcc is small, the overflow of the reference voltage Vref is small as shown by A1, but as the slope of the power voltage Vcc becomes larger, the overflow of the reference voltage Vref becomes larger as shown by B1, C1, and D1. The reason for this is that an inrush current exceeding the current iBGR=0.125 uA is instantaneously supplied.

A2, B2, C2, and D2 in FIG. 3(C) represent the internal supply voltage INTVDD corresponding to the slopes A, B, C and D of the power voltage. The stable internal supply voltage INTVDD after the power voltage Vcc reaches 3.6 V is, for example, 1.8 V. Since the internal supply voltage INTVDD is generated using the reference voltage Vref, when the reference voltage Vref overflows, the internal supply voltage INTVDD also overflows correspondingly as shown by B2, C2, and D2. In a case where the slope of the power voltage Vcc is small, no overflow occurs as shown by A2. If the internal supply voltage INTVDD generates a large overflow, when it exceeds the breakdown voltage of the transistors in the internal circuit, it may cause damage to the transistors or failure of the internal circuit, thereby reducing the reliability of the semiconductor device.

The object of the present invention is to solve this issue, and thus to provide a reference voltage generation circuit that may generate a stable reference voltage when a power voltage is applied.

The reference voltage generation circuit of the present invention includes: a BGR circuit that generates a reference current utilizing a bandgap of a diode-connected semiconductor element in a first current path; a voltage generation part that replicates the reference current in a second current path and generates a reference voltage based on the reference current; and a variable component that makes resistance values of a first resistor connected to the first current path and a second resistor connected to the second current path variable during a specific operation.

By the present invention, the resistance values of the first resistor in the first current path and the second resistor in the second current path are made variable during the specific operation, therefore fluctuations of the reference voltage due to changes in the current supplied from the power voltage during the specific operation may be suppressed.

### BRIEF DESCRIPTION OF THE DRAWINGS

FIG. 1 is a circuit diagram of a structure of a conventional reference voltage generation circuit.

FIG. 2 is a diagram of an example of a conventional internal voltage generation circuit.

FIG. 3(A) to FIG. 3(C) are diagrams of voltage waveforms of respective parts of a conventional reference voltage generation circuit when the power voltage Vcc is applied.

FIG. 4 is a diagram showing a structure of a reference voltage generation circuit according to an embodiment of the present invention.

FIG. 5(A) is an example of resistor/current iBGR during a normal operation, and FIG. 5(B) is an example of resistor/current iBGR during power-on.

FIG. 6(A) to FIG. 6(F) are diagrams of structural examples of variable resistors according to the present embodiment.

FIG. 7(A) is a diagram for explaining operation of a resistor control part during power detection, and FIG. 7(B) is a timing chart during power detection.

FIG. 8(A) to FIG. 8(C) are diagrams of voltage waveforms of respective parts of a reference voltage generation circuit during power-on according to the present embodiment.

FIG. 9(A) and FIG. 9(B) are diagrams for explaining operation of a resistor control part during recovery from DPD mode.

### DESCRIPTION OF THE EMBODIMENTS

An embodiment of the present invention relates to a reference voltage generation circuit mounted on a semiconductor device such as a memory or a logic. The reference voltage generation circuit generates a reference voltage Vref based on a power voltage Vcc supplied from outside. In one aspect, the reference voltage Vref is used to generate a supply voltage supplied to an internal circuit of the semiconductor device.

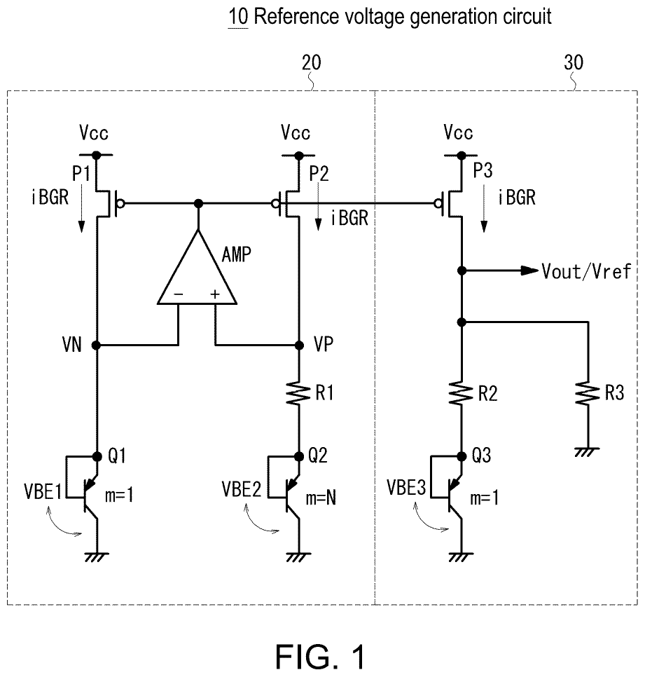

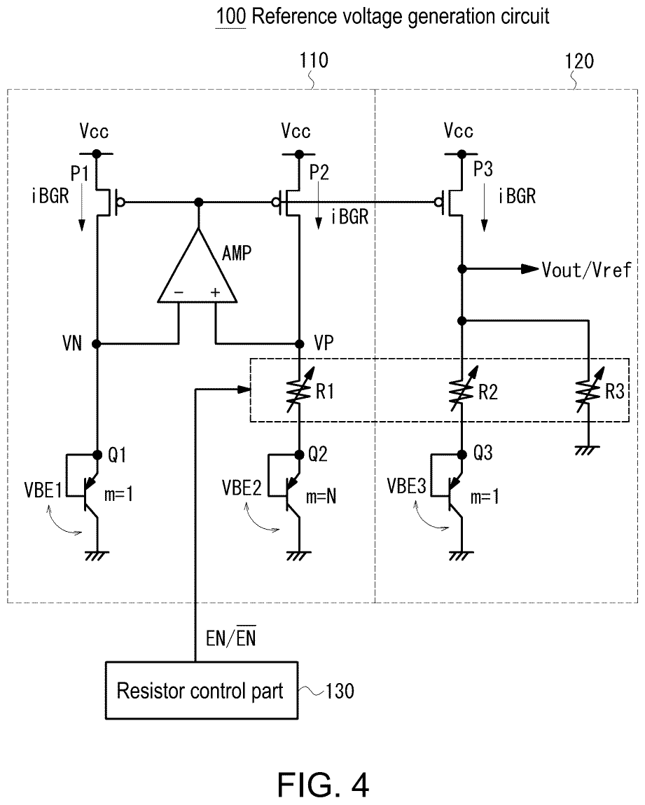

Next, embodiments of the present invention will be described in detail with reference to the drawings. FIG. 4 is a diagram of a structure of a reference voltage generation circuit according to the present embodiment. The reference voltage generation circuit 100 includes a BGR circuit 110, a voltage generation part 120, and a resistor control part 130. The BGR circuit 110 and the voltage generation part 120 have the same configuration as the BGR circuit 20 and the voltage generation part 30 shown in FIG. 1, except that the resistance values of the resistor R1, the resistor R2, and the resistor R3 may be varied.

The BGR circuit 110 includes a first current path and a second current path between a power voltage Vcc supplied from outside and GND. In the first current path, a PMOS transistor P1 and a PNP bipolar transistor Q1 are connected in series. In the second current path, a PMOS transistor P2, a variable resistor R1, and a PNP bipolar transistor Q2 are connected in series. The BGR circuit 110 further includes a differential amplifier AMP that receives a node VN at an inverting input terminal (−), receives a node VP at a non-inverting input terminal (+), and has an output terminal connected to a common gate of the transistor P1 and the transistor P2.

The variable resistor R1 is configured to vary a resistance value according to an enable signal EN (and/or/EN) from the resistor control part 130. Specifically, during an application of the power voltage Vcc, i.e., when the power voltage Vcc changes, the resistor control part 130 makes the resistance value of the variable resistor R1 relatively smaller than during a normal operation.

The voltage generation part 120 includes a third current path between the power voltage Vcc and GND. In the third current path, a PMOS transistor P3, a variable resistor R2, and a bipolar transistor Q3 are connected in series. A variable resistor R3 is connected in parallel with the variable resistor R2.

The variable resistor R2 and the variable resistor R3 are also configured to vary resistance values according to the enable signal EN from the resistor control part 130. Specifically, during the application of the power voltage Vcc, i.e., when the power voltage Vcc changes, the resistor control part 130 makes the resistance values of the variable resistor R2 and the variable resistor R3 relatively smaller than during the normal operation.

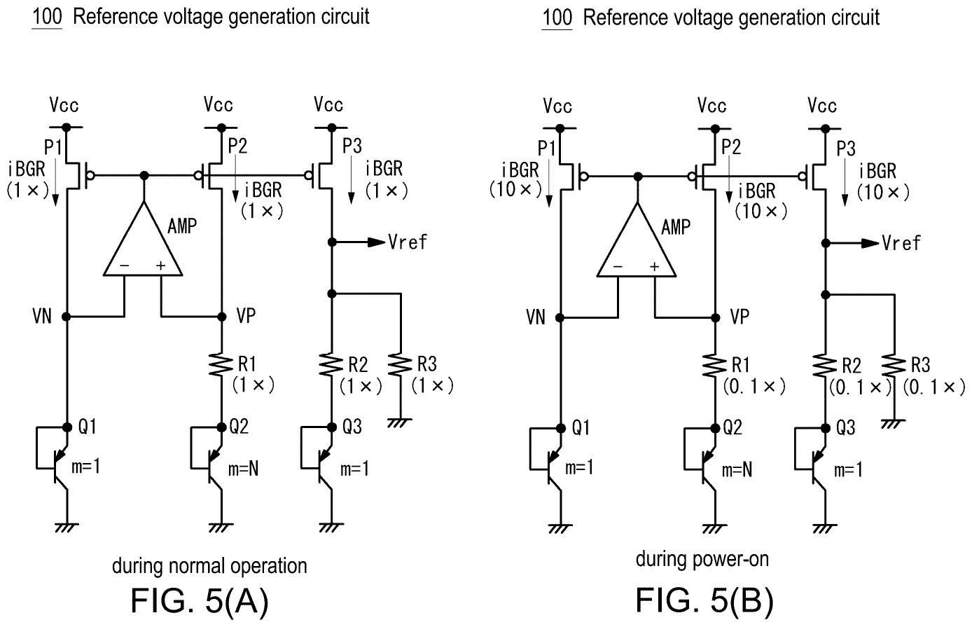

FIG. 5(A) illustrates the variable resistor R1, the variable resistor R2, the variable resistor R3, and the current iBGR during the normal operation. FIG. 5(B) illustrates the variable resistor R1, the variable resistor R2, the variable resistor R3, and the current iBGR during the application of the power voltage Vcc (i.e., during power-on).

During the normal operation, the resistance values of the variable resistor R1, the variable resistor R2, and the variable resistor R3 are designed and set so that the reference voltage generation circuit 100 generates a desired reference voltage Vref, and are represented here by a ratio of (1×). At this time, the current iBGR flowing through the BGR circuit 110 and the voltage generation part 120 is a current designed and set to generate the desired reference voltage Vref, and is represented here by a ratio of (1×).

On the other hand, the resistance values of the variable resistor R1, the variable resistor R2, and the variable resistor R3 during power-on are smaller than during the normal operation. In the example of the figure, the resistance values of the variable resistor R1, the variable resistor R2, and the variable resistor R3 are 1/10 of those during the normal operation, represented by a ratio of (0.1×). The variable resistor R1, the variable resistor R2, and the variable resistor R3 are each changed at the same ratio. At this time, the current iBGR flowing in the BGR circuit 110 and the voltage generation part 120 becomes 10 times that during the normal operation, represented by a ratio of (10×).

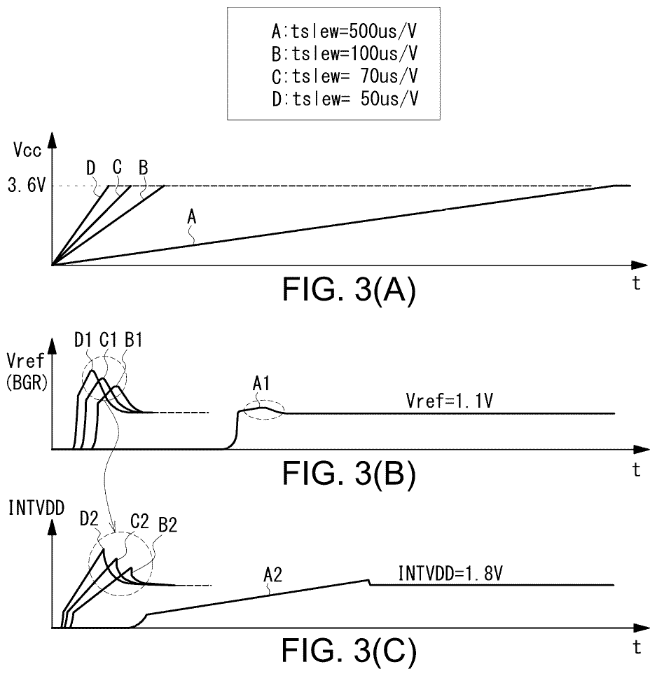

By thus making the resistance values of the variable resistor R1, the variable resistor R2, and the variable resistor R3 during power-on smaller than during the normal operation, and increasing current capacity of the current iBGR generated in the current path, most of the inrush current generated due to the rapid rise of the power voltage Vcc flows into GND, thereby suppressing significant overflow of the reference voltage Vref. Furthermore, the resistance values of the variable resistor R1, the variable resistor R2, and the variable resistor R3 during power-on, and the period during which the resistance values of the variable resistor R1, the variable resistor R2, and the variable resistor R3 are varied, are set according to the magnitude of the supplied power voltage Vcc, or the slopes A, B, C and D, etc. of the rise of the power voltage Vcc as shown in FIG. 3(A).

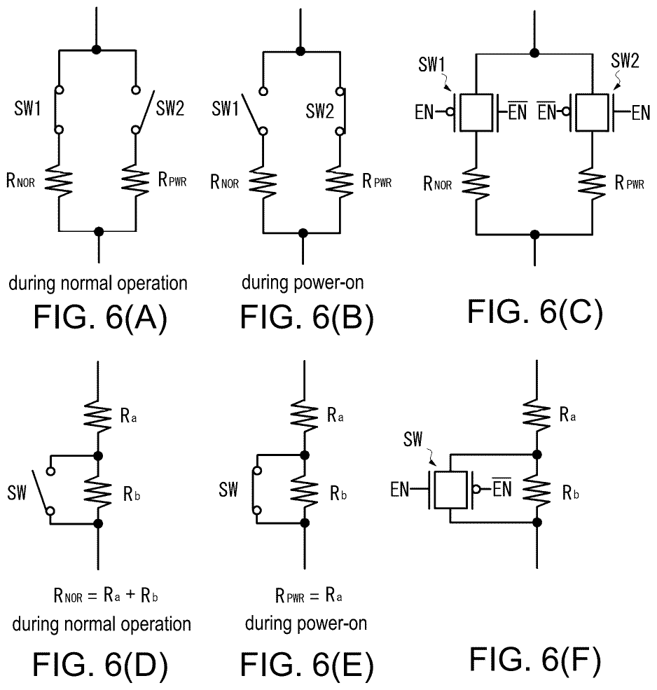

FIG. 6(A) to FIG. 6(F) are diagrams of structural examples of the variable resistor R1, the variable resistor R2, and the variable resistor R3. The variable resistors shown in FIG. 6(A) and FIG. 6(B) include a parallel connection of a switch SW1 and a resistor R_{NOR} connected in series, and a switch SW2 and a resistor R_{PWR} connected in series. In FIG. 6(A), during the normal operation, the switch SW1 is closed, the switch SW2 is open, and the resistance value of the variable resistor is R_{NOR}. In FIG. 6(B), during power-on, the switch SW1 is open, the switch SW2 is closed, and the resistance value of the variable resistor is R_{PWR}.

The switch SW1 and the switch SW2 include, for example, a Complementary Metal Oxide Semiconductor (CMOS) analog switch as shown in FIG. 6(C). The resistor control part 130 applies complementary enable signals EN and enable signals/EN to the gates of the switch SW1 and the switch SW2. The enable signal EN is at L level during the normal operation. During the normal operation, the switch SW1 is turned on, the switch SW2 is turned off, and the resistance value of the variable resistor is the resistor R_{NOR}. During power-on, the enable signal EN becomes H level, the switch SW1 is turned off, the switch SW2 is turned on, and the resistance value of the variable resistor is the resistor R_{PWR}. According to the examples of FIG. 5(A) and FIG. 5(B), resistor R_{NOR}/resistor R_{PWR}=10.

The variable resistors shown in FIG. 6(D) and FIG. 6(E) include a resistor Rₐ and a resistor R_{b} connected in series, and a switch SW connected in parallel with the resistor R_{b}. In FIG. 6(D), during the normal operation, the switch SW is open, and the resistance value of the variable resistor is Rₐ+R_{b}(=R_{NOR}). In FIG. 6(E), during power-on, the switch SW is closed, and the resistance value of the variable resistor is Rₐ(=R_{PWR}).

The switch SW includes, for example, a CMOS analog switch as shown in FIG. 6(F). The resistor control part 130 applies the complementary enable signal EN and enable signal/EN to each gate of the switch SW. During the normal operation, the enable signal EN is at L level, the switch SW is turned off, and the resistance value of the variable resistor becomes Rₐ+R_{b}(=R_{NOR}). During power-on, the enable signal EN becomes H level, the switch SW is turned on, and the resistance value of the variable resistor becomes Rₐ(=R_{PWR}). According to the examples of FIG. 5(A) and FIG. 5(B), (Rₐ+R_{b})/resistor Rₐ=10. Furthermore, the structures of the variable resistors shown in FIG. 6(A) to FIG. 6(F) are examples, and the variable resistors may also have structures other than these.

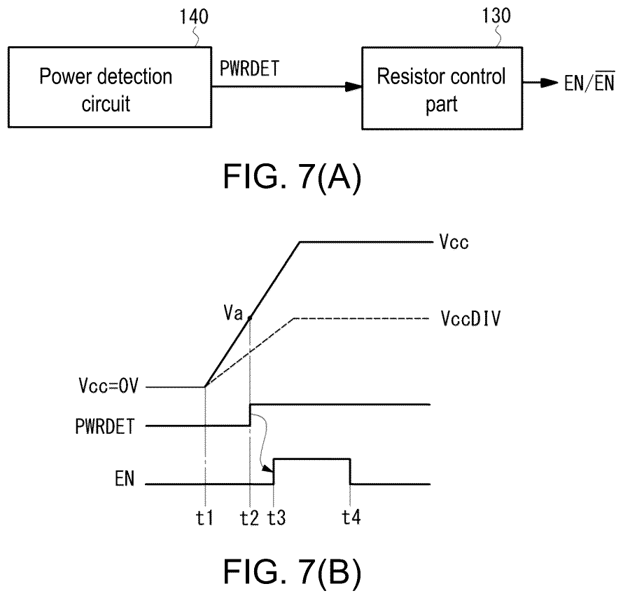

FIG. 7(A) is a diagram for explaining the operation of the resistor control part 130 during power-on. In a semiconductor device such as a flash memory, a power detection circuit 140 is typically provided to detect whether the power voltage Vcc reaches a certain voltage during power-on. When the power detection circuit 140 detects that the power voltage Vcc is above a certain level, a power-on sequence is executed to perform reset of the internal circuit or reading of fuse data, etc.

In one aspect of this embodiment, the resistor control part 130 receives the power detection signal PWRDET from the power detection circuit 140, and changes the resistance values of the variable resistor R1, variable resistor R2, and variable resistor R3 in response thereto. FIG. 7(B) is a timing diagram for explaining the operation. The power voltage Vcc is applied at time t1. The power detection circuit 140 compares a reference voltage VccDIV obtained by resistively dividing the power voltage Vcc with the power voltage Vcc, and when the power voltage Vcc reaches a voltage Va exceeding the reference voltage VccDIV at time t2, the power detection signal PWRDET transitions from L level to H level.

In response to the power detection signal PWRDET transitioning to H level, during the period from time t3 to time t4, the resistor control part 130 causes the enable signal EN to transition to H level and maintain it for a certain time. The variable resistor R1, the variable resistor R2, and the variable resistor R3 of the reference voltage generation circuit 100 change their resistance values in response to the enable signal EN. The period from time t3 to time t4 is set to cover various rising speeds of the power voltage Vcc (for example, including the time range for the power voltage Vcc to rise to 3.6 V with the slopes B, C, and D shown in FIG. 3(A) to FIG. 3(C)).

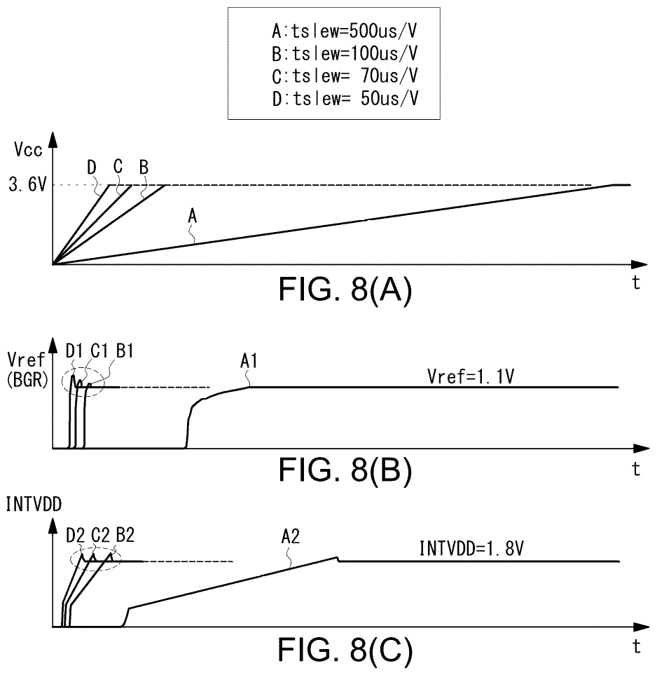

FIG. 8(A) to FIG. 8(C) are waveform diagrams of various parts of the reference voltage generation circuit of this embodiment during power-on. A, B, C, and D in FIG. 8(A) indicate different slopes until the power voltage Vcc rises to 3.6 V, which are the same as the rise of the power voltage Vcc shown in FIG. 3(A).

A1, B1, C1, and D1 in FIG. 8(B) indicate the overflow of the reference voltage Vref corresponding to the slopes A, B, C and D. In this embodiment, by reducing the resistance values of the variable resistor R1, the variable resistor R2, and the variable resistor R3 during power-on and increasing the current capacity of the current iBGR, compared to conventional reference voltage generation circuits, most of the inrush current of the power voltage Vcc flows to GND, thereby reducing the overflow of the reference voltage Vref.

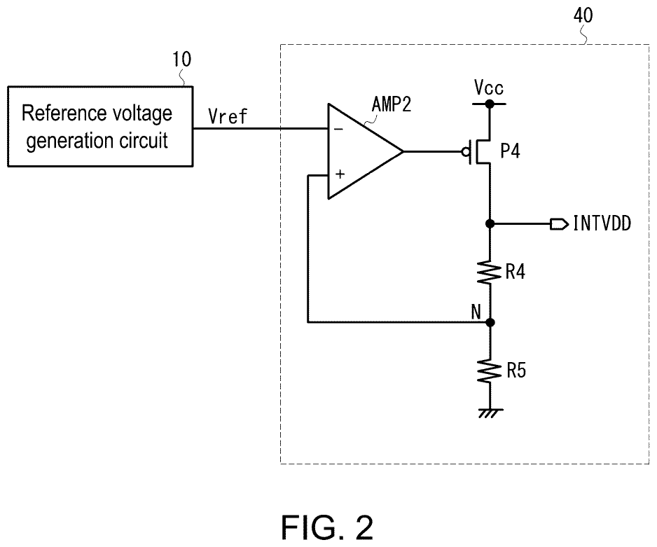

A2, B2, C2, and D2 in FIG. 8(C) indicate the internal supply voltage INTVDD corresponding to the slopes A, B, C and D. The internal supply voltage INTVDD is generated using the reference voltage Vref (refer to FIG. 2), and therefore overflow occurs according to the reference voltage Vref. However, in this embodiment, as described above, the overflow of the reference voltage Vref is significantly suppressed, and therefore the overflow of B2, C2, and D2 of the internal supply voltage INTVDD is also suppressed to be very small. Thereby, the internal supply voltage INTVDD may be prevented from exceeding the withstand voltage of the transistors of the internal circuit, preventing destruction of the transistors or failure of the internal circuit, and thus the reliability of the semiconductor device may be improved.

Next, another embodiment of the present invention will be described. In the aforementioned embodiment, an example of changing the resistance value of the variable resistor during power-on was shown, but in another embodiment, the resistance value of the variable resistor is changed when recovering from Deep Power-Down (DPD) mode.

The semiconductor device has a standby mode that may limit the operation of the internal circuit to maintain power consumption below a certain level. Although it is the standby mode, an off-leakage current is generated in the circuit, consuming a certain degree of power. DPD mode further reduces power consumption in the standby mode. In DPD mode, power supply to the reference voltage generation circuit 100 is cut off, and the off-leakage current is reduced. Regarding DPD mode, for example, DPD mode may be entered by a DPD activation command, and recovery from DPD mode may be performed by a DPD release command. When recovering from DPD mode, the power voltage Vcc is reapplied to the reference voltage generation circuit 100, and therefore, as in the case of power-on, overflow of the reference voltage Vref may occur due to instantaneous inrush current.

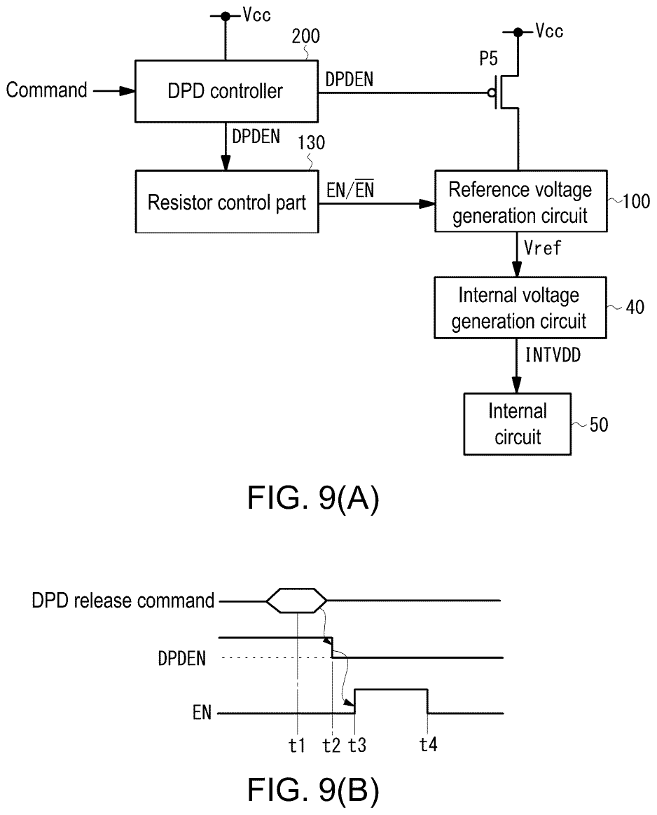

FIG. 9(A) is a diagram of a structure related to DPD mode of the semiconductor device. A PMOS transistor P5 is connected between the power voltage Vcc and the reference voltage generation circuit 100, and a DPD enable signal DPDEN from a DPD controller 200 is applied to the gate of the transistor P5. The DPD controller 200 operates directly using the power voltage Vcc. In an active mode and the standby mode, the DPD controller 200 outputs the L level DPD enable signal DPDEN to turn on the transistor P5, supplying the power voltage Vcc to the reference voltage generation circuit 100. The reference voltage generation circuit 100 supplies the generated reference voltage Vref to the internal voltage generation circuit 40, and the internal voltage generation circuit 40 supplies the generated internal supply voltage INTVDD to the internal circuit 50.

When receiving the DPD activation command, the DPD controller 200 outputs the H level DPD enable signal DPDEN to turn off the transistor P5, cutting off the supply of the power voltage Vcc and stopping the operation of the reference voltage generation circuit 100.

When releasing DPD mode, a DPD release command is input to the semiconductor device. When receiving the DPD release command, the DPD controller 200 outputs the L level DPD enable signal DPDEN to turn on the transistor P5, supplying the power voltage Vcc to the reference voltage generation circuit 100. At this time, the power voltage Vcc may change rapidly in the same manner as during power-on.

In this embodiment, the DPD controller 200 applies the DPD enable signal DPDEN to the resistor control part 130. When the resistor control part 130 receives the DPD enable signal DPDEN that transitions from H level to L level, the resistor control part 130 applies the enable signal EN for reducing the resistance values of the variable resistor R1, the variable resistor R2, and the variable resistor R3 to the reference voltage generation circuit 100.

FIG. 9(B) is a timing diagram for explaining the operation of the resistor control part 130. At time t1, the DPD controller 200 receives the DPD release command, and at time t2, the DPD enable signal DPDEN transitions from H level to L level. The resistor control part 130 applies the enable signal EN that transitions to H level to the variable resistor R1, the variable resistor R2, and the variable resistor R3 for a certain period from time t3 to time t4 in response to the DPD enable signal DPDEN transitioning to L level. Thereby, the resistance values of the variable resistor R1, the variable resistor R2, and the variable resistor R3 become smaller, the current iBGR becomes larger, and the overflow of the reference voltage Vref caused by the inrush current is suppressed.

Next, another embodiment of the present invention will be described. In the aforementioned embodiment, an example in which the reference voltage generation circuit 100 includes the BGR circuit 110 and the voltage generation part 120 was described, but in this embodiment, the reference voltage generation circuit 100 includes only the BGR circuit 110 and does not include the voltage generation part 120. In this case, one or more resistors may be added to the first current path and/or the second current path of the BGR circuit 110 to obtain a desired reference voltage or reference current, or the reference voltage or reference current may also be directly extracted from the second current path.

By making, as in the aforementioned embodiment, the resistors of the BGR circuit 110 variable in such a manner that the resistance values become smaller when power is turned on or when recovering from a power saving mode, thereby enabling the BGR circuit 110 to be started up quickly when power is turned on or when recovering from the power saving mode.

In the aforementioned embodiment, an example is shown in which the resistance value of the variable resistor during power-on becomes 1/10 of that during the normal operation, but this is one example, and may be appropriately set according to the characteristics of the reference voltage generation circuit. Additionally, the reference voltage generation circuit shown in FIG. 4 uses the resistor R3 to adjust the reference voltage Vref, but the resistor R3 is not necessarily required. Furthermore, in the aforementioned embodiment, an example is shown in which the BGR circuit uses a differential amplifier, but VN=VP may alternatively be performed by an N type metal oxide semiconductor (NMOS) current mirror. Furthermore, in the aforementioned embodiment, an example is shown in which the resistance value of the variable resistor is changed when power is turned on or when recovering from DPD mode, but the present invention is not limited to the aforementioned scenarios, and the resistance value of the variable resistor may also be changed when power supply to the BGR circuit is restarted for some reason, or during operation in which the supplied power voltage may change.

The preferred embodiments of the present invention have been described in detail, but the present invention is not limited to specific embodiments, and various modifications and changes may be made within the scope of the gist of the invention as described in the claims.

What is claimed is:

1. A reference voltage generation circuit, comprising:
a bandgap reference circuit that generates a reference current utilizing a bandgap of a diode-connected semiconductor element in a first current path;
a voltage generation part that replicates the reference current in a second current path and generates a reference voltage based on the reference current; and
a variable component that, during a specific operation, makes resistance values of a first resistor connected to the first current path and a second resistor connected to the second current path variable.

2. The reference voltage generation circuit as claimed in claim 1, wherein the variable component reduces the resistance values of the first resistor and the second resistor at a same ratio relative to the resistance values during a normal operation.

3. The reference voltage generation circuit as claimed in claim 1, wherein the variable component reduces the resistance values of the first resistor and the second resistor for a certain period during the specific operation.

4. The reference voltage generation circuit as claimed in claim 1, wherein the variable component makes the reference current larger than the reference current during a normal operation for a certain period during the specific operation.

5. The reference voltage generation circuit as claimed in claim 1, wherein the specific operation is when power is turned on.

6. The reference voltage generation circuit as claimed in claim 5, wherein the variable component reduces the resistance values of the first resistor and the second resistor in response to a detection signal from a power detection circuit.

7. The reference voltage generation circuit as claimed in claim 1, wherein the specific operation is when recovering from a power saving mode.

8. The reference voltage generation circuit as claimed in claim 7, wherein the variable component reduces the resistance values of the first resistor and the second resistor in response to receiving a command for releasing the power saving mode.

9. The reference voltage generation circuit as claimed in claim 1, wherein the reference current is represented by reference current=(1/R)×Vt×ln(N), where Vt=kT/q, k is Boltzmann constant, T is an absolute temperature, q is charge quantity, N is an emitter area ratio of bipolar transistors, and R is the first resistor.

10. A reference voltage generation circuit, comprising:
a bandgap reference circuit that generates a reference current utilizing a bandgap of a diode-connected semiconductor element in a current path; and
a variable component that varies a resistance value of a resistor connected to the current path during a specific operation.

11. The reference voltage generation circuit as claimed in claim 10, wherein the variable component makes the reference current larger than the reference current during a normal operation for a certain period during the specific operation.

12. The reference voltage generation circuit as claimed in claim 10, wherein the specific operation is when power is turned on or when recovering from a power saving mode.

13. A semiconductor device, comprising:
the reference voltage generation circuit as claimed in claim 1; and
an internal voltage generation part that generates an internal supply voltage based on a reference voltage generated by the reference voltage generation circuit.

14. A semiconductor device, comprising:
the reference voltage generation circuit as claimed in claim 10; and
an internal voltage generation part that generates an internal supply voltage based on a reference voltage generated by the reference voltage generation circuit.
